(19) United States
(12) Patent Application Publication
(10) Pub. No.: US 2008/0248299 A1
(43) Pub. Date: Oct. 9, 2008

(54) Pressure-Sensitive Adhesive and Method for Producing Same, and Pressure-Sensitive Adhesive Sheet

(75) Inventors: Yasuto Kuwahara, Tokyo (JP); Shoichi Fukumoto, Tokyo (JP); Naotoshi Nakamura, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYO INK MFG. CO., LTD.

(21) Appl. No.: 12/065,530

(22) PCT Filed: Sep. 2, 2005
(86) PCT No.: PCT/JP2005/016148

§ 371 Date: Mar. 3, 2008

(51) Int. Cl. C08G 63/91; B32B 7/12

(52) U.S. Cl. 428/355 R; 525/418

(57) ABSTRACT

A pressure-sensitive adhesive, comprising a polymer (A), which is formed by polymerization of a radical polymerizable monomer, contains carboxyl groups, and has a glass transition temperature within a range from −80 to 0° C. and a weight average molecular weight within a range from 500,000 to 1,500,000, a tricyclic diterpene carboxylic acid (B), and a curing agent (C) capable of reacting with a carboxyl group, wherein the total acid value of the combination of the polymer (A) and the tricyclic diterpene carboxylic acid (B) is within a range from 5 to 50 (mgKOH/g).

### TECHNICAL FIELD

The present invention relates to a pressure-sensitive adhesive sheet, a pressure-sensitive adhesive capable of forming the pressure-sensitive adhesive sheet, and a method for producing the pressure-sensitive adhesive.

### BACKGROUND ART

Various types of flat panel displays (FPD) are now being used as display devices in all manner of fields. For example, FPDs are not only being used indoors for applications such as personal computer displays and liquid crystal televisions, but are also being mounted within vehicles as the displays for car navigation systems and the like. Examples of these FPDs include liquid crystal displays (LCD), plasma displays (PDP), rear projection displays (RPJ), EL displays, and light emitting diode displays.

These display devices use antireflective films to prevent reflections from external light sources, and protective films to prevent scratching of the surface of the display device.

Moreover, FPDs are not only used as display devices, but can also be used as input devices by providing a touch panel function on the display surface. This touch panel also uses a protective film, antireflective film and/or ITO vapor deposited resin film or the like.

Of the above FPDs, LCDs also comprise a polarization film and/or phase difference film laminated on a glass member for a liquid crystal cell.

The various films used in display devices are bonded to their respective adherends using pressure-sensitive adhesives. Because they are used in display devices, these pressure-sensitive adhesives need to exhibit excellent transparency. As a result, pressure-sensitive adhesives comprising an acrylic resin of excellent transparency as the main constituent are widely used.

However, of the various films mentioned above, polarization films have a 3-layered structure in which the two surfaces of a polarizer comprising a polyvinyl alcohol as the main component are sandwiched between triacetyl cellulose-based protective films. This polarizer comprising a polyvinyl alcohol as the main component and these triacetyl cellulose-based protective films both undergo significant expansion and contraction upon changes in heating or changes in humidity. As a result, the polarization film also undergoes marked dimensional change upon changes in heating or changes in humidity.

Accordingly, a pressure-sensitive adhesive used for bonding a polarization film to the glass member for a liquid crystal cell requires sufficient toughness to resist these dimensional changes within the polarization film, so that the adhesive state can be maintained with no lifting or peeling of the polarization film from the glass member of the liquid crystal cell. In order to achieve such toughness, the pressure-sensitive adhesive layer requires not only a powerful adhesive strength (the peel strength), but also a large cohesive force (holding force).

However, if the pressure-sensitive adhesive layer is overly tough, then new problems such as those described below tend to arise.

When a LCD is used over a long period of time, the dimensions of the polarization film continue to change. However if the pressure-sensitive adhesive layer is overly tough, then the pressure-sensitive adhesive layer is unable to absorb and alleviate the stress caused by these dimensional changes within the polarization film, meaning stress accumulates in the peripheral regions of the polarization film. As a result, the brightness differs for the peripheral regions and the central region of the LCD, which causes color irregularities and white leakage (light leakage) at the LCD surface.

In particular, in recent years, increases in the sizes of LCDs have lead to increases in the size of the polarization film. This has increased the likelihood of color irregularities and white leakage at the LCD surface.

When any of the various films such as a polarization film is bonded to the surface of a display device or a touch panel (namely, an adherend such as a glass member), the resulting structure is tested for the presence of air or the presence of dust at the bonding interface, and if air or dust is detected, the film is peeled off and a new film is bonded. Accordingly, it is desirable that the pressure-sensitive adhesive leaves no residual adhesive on the adherend.

In this manner, the pressure-sensitive adhesives used for bonding various films to display devices and the like are required to exhibit favorable optical properties (transparency), favorable adhesion to the adherend even when exposed to high temperatures or conditions of high temperature and high humidity, favorable stress relaxation properties even when exposed to high temperatures, and to leave no adhesive on the adherend when peeled off (namely, favorable removability).

Many pressure-sensitive adhesives have been proposed in order to meet these various requirements.

For example, a pressure-sensitive adhesive is known that comprises an acrylic resin in which the main component is an alkyl (meth)acrylate ester containing an alkyl group of 1 to 12 carbon atoms, wherein the pressure-sensitive adhesive comprises not more than 15% by weight of an acrylic polymer component having a weight average molecular weight of not more than 100,000, and at least 10% by weight of an acrylic polymer component having a weight average molecular weight of at least 1,000,000 (see Japanese Patent Laid-Open No. H01-66283).

Another known pressure-sensitive adhesive comprises, as the main component, a copolymer with a weight average molecular weight within a range from 500,000 to 2,000,000, obtained by copolymerizing an alkyl (meth)acrylate ester, a functional group-containing monomer, and a specific macromonomer containing an α,β-unsaturated group (see Japanese Patent Laid-Open No. H08-209095).

Another known pressure-sensitive adhesive for a polarization plate comprises 100 parts by weight of a high molecular weight (meth)acrylic copolymer with a weight average molecular weight of at least 1,000,000, from 20 to 200 parts by weight of a low molecular weight (meth)acrylic copolymer with a weight average molecular weight of not more than 30,000, and from 0.005 to 5 parts by weight of a polyfunctional compound capable of forming cross-linking structures between the above copolymers (see Japanese Patent Laid-Open No. H10-279907).

Another known pressure-sensitive adhesive for a polarization film comprises a high molecular weight acrylic polymer containing reactive functional groups and having a weight average molecular weight within a range from 1,000,000 to 2,500,000, a low molecular weight acrylic polymer with a weight average molecular weight within a range from 30,000 to 100,000 and having a glass transition point (Tg) within a range from 0 to −80° C., and a polyfunctional compound containing functional groups capable of forming cross-linking structures with the high molecular weight acrylic polymer (see Japanese Patent Laid-Open No. 2002-121521).

Moreover, although not reported as pressure-sensitive adhesives for the various type of displays, various other pressure-sensitive adhesives comprising an acrylic polymer as the main constituent are also known (see Japanese Patent Laid-Open No. 2004-51812, Japanese Patent Laid-Open No. 2005-139323, and Japanese Patent Laid-Open No. 2004-315767).

Japanese Patent Laid-Open No. 2004-51812 discloses a pressure-sensitive adhesive comprising an acrylic polymer and a rosin ester. However, simply including an acrylic polymer and a rosin ester does not yield totally satisfactory adhesive properties (heat resistance and humidity resistance) relative to the adherend.

### DISCLOSURE OF INVENTION

An object of the present invention is to provide a pressure-sensitive adhesive that is capable of forming a pressure-sensitive adhesive sheet which exhibits favorable optical properties (transparency), favorable adhesion to an adherend even when exposed to high temperatures or conditions of high temperature and high humidity, favorable stress relaxation properties even when exposed to high temperatures, and favorable removability that leaves no residual adhesive upon peeling.

The present invention relates to a pressure-sensitive adhesive comprising a polymer (A), which is formed by polymerization of a radical polymerizable monomer, contains carboxyl groups, and has a glass transition temperature within a range from −80 to 0° C. and a weight average molecular weight within a range from 500,000 to 1,500,000, a tricyclic diterpene carboxylic acid (B), and a curing agent (C) capable of reacting with a carboxyl group, wherein the total acid value of the combination of the polymer (A) and the tricyclic diterpene carboxylic acid (B) is within a range from 5 to 50 (mgKOH/g).

Another aspect of the present invention relates to a method for producing a pressure-sensitive adhesive, comprising:

polymerizing a radical polymerizable monomer until a polymerizable ratio of 70 to 90% is reached, using from 0.02 to 0.13 mols of a peroxide as a first polymerization initiator relative to 100 mols of the radical polymerizable monomer;

continuing the polymerization using a second polymerization initiator until a polymerizable ratio of at least 99% is reached, thereby synthesizing a carboxyl group-containing polymer (A) with a glass transition temperature within a range from −80 to 0° C. and a weight average molecular weight within a range from 500,000 to 1,500,000; and

mixing the polymer (A), a sufficient quantity of a tricyclic diterpene carboxylic acid (B) to generate a total acid value for the combination with the polymer (A) that is within a range from 5 to 50 (mgKOH/g), and a curing agent (C) containing a functional group capable of reacting with a carboxyl group.

### BEST MODE FOR CARRYING OUT THE INVENTION

As a result of the composition described above, the pressure-sensitive adhesive according to the present invention exhibits excellent adhesion to a variety of adherends, as well as excellent heat resistance, humidity resistance, removability, holding force, and transparency.

Accordingly, by using the pressure-sensitive adhesive according to the present invention, a pressure-sensitive adhesive sheet can be formed which exhibits favorable optical properties (transparency), favorable adhesion to an adherend even when exposed to high temperatures or conditions of high temperature and high humidity, favorable stress relaxation properties even when exposed to high temperatures, and favorable removability that leaves no residual adhesive upon peeling.

Using this pressure-sensitive adhesive sheet means that when an LCD is used over a long period of time, lifting or peeling of the polarization film from the polarizer can be prevented, enabling the occurrence of color irregularities or white leakage at the LCD surface to be suppressed.

The pressure-sensitive adhesive of the present invention can be used favorably for bonding not only polarization films, but also various other optical members, and can also be used in a variety of other applications.

The polymer (A) is a polymer containing carboxyl groups formed by polymerization of a radical polymerizable monomer, and has a glass transition temperature within a range from −80 to 0° C. and a weight average molecular weight within a range from 500,000 to 1,500,000. The polymerization of this radical polymerizable monomer is preferably conducted within an organic solvent.

The radical polymerizable monomer is a compound that contains a polymerizable double bond within its molecular structure (namely, a radical polymerizable unsaturated monomer), and there are no particular restrictions on the monomer provided it is an alkenyl group-containing compound or an α,β-unsaturated carboxylate ester or the like.

Examples of preferred monomers include:

alkyl (meth)acrylate esters such as methyl (meth)acrylate, ethyl (meth)acrylate, isopropyl (meth)acrylate, propyl (meth)acrylate, n-butyl (meth)acrylate, isobutyl (meth)acrylate, t-butyl (meth)acrylate, n-amyl (meth)acrylate, isoamyl (meth)acrylate, n-hexyl (meth)acrylate, 2-ethylhexyl (meth)acrylate, n-octyl (meth)acrylate, decyl (meth)acrylate, dodecyl (meth)acrylate, octadecyl (meth)acrylate, lauryl (meth)acrylate, and stearyl (meth)acrylate;

cyclic (meth)acrylate esters such as cyclohexyl (meth)acrylate, benzyl (meth)acrylate, isobornyl (meth)acrylate, phenyl (meth)acrylate, and phenoxyethyl (meth)acrylate;

unsaturated group-containing (meth)acrylate esters such as allyl (meth)acrylate, 1-methylallyl (meth)acrylate, 2-methylallyl (meth)acrylate, 1-butenyl (meth)acrylate, 2-butenyl (meth)acrylate, 3-butenyl (meth)acrylate, 1,3-methyl-3-butenyl (meth)acrylate, 2-chloroallyl (meth)acrylate, 3-chloroallyl (meth)acrylate, o-allylphenyl (meth)acrylate, 2-(allyloxy)ethyl (meth)acrylate, allyllactyl (meth)acrylate, citronellyl (meth)acrylate, geranyl (meth)acrylate, rhodinyl (meth)acrylate, cinnamyl (meth)acrylate, diallyl maleate, diallylitaconic acid, vinyl (meth)acrylate, vinyl crotonate, vinyl oleate, and vinyl linolenate;

hydroxyl (or alkoxyl) group-containing (meth)acrylate esters such as 2-hydroxyethyl (meth)acrylate, hydroxypropyl (meth)acrylate, 2-methoxyethyl (meth)acrylate, and 2-ethoxyethyl (meth)acrylate;

amino group-containing (meth)acrylate esters such as N-methylaminoethyl (meth)acrylate, N-tributylaminoethyl (meth)acrylate, N,N-dimethylaminoethyl (meth)acrylate, and N,N-diethylaminoethyl (meth)acrylate;

alkoxysilyl group-containing (meth)acrylate esters such as 3-methacryloxypropyltrimethoxysilane, 3-methacryloxypropyltriethoxysilane, 3-methacryloxypropyltriisopropoxysilane, 3-methacryloxypropylmethyldimethoxysilane, and 3-methacryloxypropylmethyldiethoxysilane;

(meth)acrylic acid derivatives such as methoxyethyl (meth)acrylate, and ethylene oxide adducts of (meth)acrylic acid;

perfluoroalkyl (meth)acrylate esters such as perfluoroethyl (meth)acrylate, perfluoropropyl (meth)acrylate, perfluorobutyl (meth)acrylate, and perfluorooctyl (meth)acrylate;

polyfunctional (meth)acrylate esters such as ethylene glycol di(meth)acrylate, triethylene glycol di(meth)acrylate, tetraethylene glycol di(meth)acrylate, trimethylolpropane tri(meth)acrylate, pentaerythritol tri(meth)acrylate, 1,1,1-trishydroxymethylethane diacrylate, 1,1,1-trishydroxymethylethane triacrylate, and 1,1,1-trishydroxymethylpropane triacrylate;

aromatic vinyl-based monomers such as styrene, α-methylstyrene, β-methylstyrene, o-methylstyrene, m-methylstyrene, p-methylstyrene, 1-butylstyrene, chlorostyrene, and styrenesulfonic acid and the sodium salt thereof;

fluorine-containing vinyl-based monomers such as perfluoromethyl (meth)acrylate, trifluoromethylmethyl (meth)acrylate, 2-trifluoromethylethyl (meth)acrylate, diperfluoromethylmethyl (meth)acrylate, 2-perfluoroethylethyl (meth)acrylate, 2-perfluoromethyl-2-perfluoroethylmethyl (meth)acrylate, triperfluoromethylmethyl (meth)acrylate, 2-perfluoroethyl-2-perfluorobutylethyl (meth)acrylate, 2-perfluorohexylethyl (meth)acrylate, 2-perfluorodecylethyl (meth)acrylate, 2-perfluorohexadecylethyl (meth)acrylate, perfluoroethylene, perfluoropropylene, and vinylidene fluoride;

trialkyloxysilyl group-containing vinyl-based monomers such as vinyltrimethoxysilane and vinyltriethoxysilane;

silicon-containing vinyl-based monomers such as γ-(methacryloyloxypropyl)trimethoxysilane;

maleimide derivatives such as maleimide, methylmaleimide, ethylmaleimide, propylmaleimide, butylmaleimide, octylmaleimide, dodecylmaleimide, stearylmaleimide, phenylmaleimide, and cyclohexylmaleimide;

heterocycle-containing (meth)acrylate esters such as glycidyl (meth)acrylate, (3,4-epoxycyclohexyl)methyl (meth)acrylate, and tetrahydrofurfuryl (meth)acrylate;

nitrile group-containing vinyl-based monomers such as acrylonitrile and methacrylonitrile;

amide group-containing vinyl-based monomers such as acrylamide and methacrylamide;

vinyl esters such as vinyl acetate, vinyl propionate, vinyl pivalate, vinyl benzoate, and vinyl cinnamate;

alkenes such as ethylene and propylene;

dienes such as butadiene and isoprene;

unsaturated carboxylic acids such as (meth)acrylic acid, itaconic acid, and maleic acid;

unsaturated carboxylic acid anhydrides such as itaconic anhydride and maleic anhydride;

monoalkyl esters and dialkyl esters of unsaturated carboxylic acids;

as well as vinyl chloride, vinylidene chloride, allyl chloride, and allyl alcohol, although the above is not an exhaustive list. Any of these monomers may be used alone, or a plurality of different monomers may be used in combination.

The polymer (A) is the main component for forming the pressure-sensitive adhesive. Accordingly, it is important that the glass transition temperature (hereafter also referred to as Tg) is within a range from −80 to 0° C., and this value is preferably within a range from −70 to −10° C. If a polymer for which the glass transition temperature is higher than 0° C. is used, then favorable adhesion cannot be assured across a wide range of adherends.

The Tg value of the polymer (A) can be determined theoretically based on the Tg values for the homopolymers formed from each of the monomers used in the copolymerization, and the proportion of each monomer used in the copolymerization. The proportion of each monomer used in the copolymerization is often reported as a weight fraction, but in the present invention, the molecular weight of each monomer is also taken into consideration, and a molar fraction is used.

In consideration of the Tg value for the prepared polymer (A), as large a quantity as possible of 2-ethylhexyl acrylate and/or n-butyl acrylate is preferably used as a radical polymerizable monomer. Specifically, the combined quantity of these two monomers is preferably at least 50% by weight, and is even more preferably from 60 to 90% by weight, relative to 100% by weight of the combination of all the radical polymerizable monomers used in the polymerization.

The polymer (A) must contain carboxyl groups, which function as the functional groups required for reaction with the curing agent (C) described below. The acid value of the carboxyl group-containing polymer (A) is preferably within a range from 10 to 50 (mgKOH/g), even more preferably from 15 to 35 (mgKOH/g), and is most preferably from 20 to 30 (mgKOH/g). If the acid value is less than 10, then the quantity of carboxyl functional groups is inadequate, and the cross-linking density decreases. In contrast, if the acid value exceeds 50 (mgKOH/g), then the polymerization stability and the adhesion to adherends are prone to deterioration.

This carboxyl group-containing polymer (A) can be prepared easily by using an unsaturated carboxylic acid such as (meth)acrylic acid, itaconic acid or maleic acid as a comonomer. Considering factors such as the polymerizability with other monomers, and the adhesion to adherends, acrylic acid is preferred. The quantity used of this unsaturated carboxylic acid is preferably within a range from 1 to 10% by weight relative to 100% by weight of the combination of all the radical polymerizable monomers used in the polymerization.

It is important that the polymer (A) has a weight average molecular weight (hereafter also referred to as Mw) within a range from 500,000 to 1,500,000, and this value is preferably from 600,000 to 1,000,000. Moreover, the value of Mw/Mn for the polymer (A) if preferably within a range from 6.5 to 12, and is even more preferably from 7 to 10. Mn refers to the number average molecular weight, and both Mw and Mn represent values determined by gel permeation chromatography (GPC) and referenced against polystyrene standards.

If exposed to high temperatures or conditions of high temperature and high humidity following bonding to an adherend, a pressure-sensitive adhesive sheet formed from a pressure-sensitive adhesive comprising a polymer with a Mw value of less than 500,000 tends to lift or peel away from the adherend. Furthermore, if this type of polymer with an overly small molecular weight is included, then the cohesive force of the pressure-sensitive adhesive layer tends to decrease.

In contrast, a pressure-sensitive adhesive comprising a polymer with a Mw value larger than 1,500,000 develops a high viscosity, and handling becomes problematic. Moreover, a pressure-sensitive adhesive comprising this type of polymer with an overly large molecular weight tends to be prone to unsatisfactory adhesion to adherends or sheet-like substrates. The reason for this observation is that if the Mw value is too large, then the resin becomes rigid, and the wetting of the adherend or sheet-like substrate, which is a required property for a pressure-sensitive adhesive, deteriorates, causing a deterioration in the adhesion.

For the polymer (A), the proportion of the area in a GPC plot represented by components with a molecular weight of 2,000,000 or higher is preferably from 3 to 15%, even more preferably from 4 to 10%, and is most preferably from 5 to 8%.

In the case of the present invention, the pressure-sensitive adhesive layer preferably exhibits a large cohesive force. Increasing the molecular weight of the polymer (A) contained within the pressure-sensitive adhesive enables the cohesive force of the pressure-sensitive adhesive layer to be increased. However, as described above, if a polymer with a large Mw value is simply used, then the pressure-sensitive adhesive becomes highly viscous, and is difficult to apply.

In comparison, the polymer (A) with a Mw value within a range from 500,000 to 1,500,000 includes a component with a molecular weight of 2,000,000 or higher, and is therefore able to increase the cohesive force of the pressure-sensitive adhesive layer without impairing the coating properties of the pressure-sensitive adhesive.

Pressure-sensitive adhesives containing a polymer in which components with a molecular weight of 2,000,000 or higher represent less than 3% cannot be expected to yield a large increase in the cohesive force. In contrast, pressure-sensitive adhesives containing a polymer that comprises 15% or more of components with a molecular weight of 2,000,000 or higher suffer from excessively high viscosity, and are difficult to handle. Moreover, as described above, this type of pressure-sensitive adhesive comprising a polymer with a large quantity of high molecular weight components tends to be prone to inferior adhesion. Furthermore, this type of polymer containing a large quantity of high molecular weight components often has a Mw value exceeding 1,500,000.

The polymer (A) can be obtained by using any of a variety of polymerization initiators, and suitably adjusting the polymerization conditions such as the quantity of the polymerization initiator and the polymerization temperature. When polymerizing the radical polymerizable monomer, the use of an azo-based compound or a peroxide as the polymerization initiator is preferred.

Examples of azo-based compounds include 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaleronitrile), dimethyl 2,2′-azobis(2-methylpropionate), 4,4′-azobis(4-cyanovaleric acid), 2,2′-azobis(2-hydroxymethylpropionitrile), and 2,2′-azobis[2-(2-imidazolin-2-yl)propane]. Of these, from the viewpoints of reactivity and polymerization stability, 2,2′-azobisisobutyronitrile is preferred.

Examples of peroxides include ketone peroxides such as methyl ethyl ketone

peroxide, cyclohexanone peroxide, and acetylacetone peroxide; peroxyketals such as 1,1-di(t-hexylperoxy)-3,3,5-trimethylcyclohexane, 1,1-di(t-hexylperoxy)cyclohexane, 1,1-di(t-butylperoxy)-2-methylcyclohexane, 1,1-di(t-butylperoxy)cyclohexane, and 2,2-di(t-butylperoxy)butane;

hydroperoxides such as p-menthane hydroperoxide, diisopropylbenzene hydroperoxide, 1,1,3,3-tetramethylbutyl hydroperoxide, and t-butyl hydroperoxide;

dialkyl peroxides such as α,α′-di(t-butylperoxy)diisopropylbenzene, dicumyl peroxide, t-butylcumyl peroxide, di-t-butyl peroxide, and di-t-hexyl peroxide;

diacyl peroxides such as diisobutyl peroxide, di(3,5,5-trimethylhexanoyl) peroxide, dilauroyl peroxide, and benzoyl peroxide;

peroxy dicarbonates such as diisopropyl peroxydicarbonate, di-n-propyl peroxydicarbonate, and bis(4-t-butylcyclohexyl) peroxydicarbonate; and

peroxy esters such as t-hexyl peroxypivalate, t-butyl peroxypivalate, t-hexyl peroxy-2-ethylhexanoate, t-butyl peroxy-2-ethylhexanoate, t-butyl peroxylaurate, and t-butyl peroxy-3,5,5-trimethylhexanoate.

When polymerizing the radical polymerizable monomer, the polymerization initiator is preferably divided into a plurality of portions for use. The polymerization initiator added in the initial stage decomposes as a result of heat and the like, and gradually loses activity as time passes. Accordingly, additional polymerization initiator is preferably added partway through the polymerization reaction. By adding additional polymerization initiator partway through the reaction, and appropriately altering the quantity and variety of polymerization initiator added, the molecular weight of the reaction product, namely the polymer, can be increased, and the quantity of residual monomer can be reduced.

The azo-based compounds that can be used as the polymerization initiator cause almost no hydrogen abstraction reactions. In contrast, if a peroxide is used, then large numbers of hydrogen abstraction reactions are initiated. When a hydrogen abstraction reaction occurs, a branched structure is introduced into the polymer with the site of the hydrogen abstraction reaction as the origin. In this manner, differences in the nature of the polymerization initiator have an effect on the properties of the resulting polymer, and the properties of the polymer solution. In particular, differences in the nature of the polymerization initiator used in the initial stage of the reaction have a large effect on the properties of the polymer and the properties of the polymer solution.

If the polymer (A) includes branching, then the branched portions become intertwined, enabling the cohesive force of the pressure-sensitive adhesive layer to be increased. Using a peroxide in the initial stage of the polymerization enables branched structures to be introduced effectively into the polymer (A), and is consequently preferred.

A polymer solution obtained by using a peroxide in the initial stage of the polymerization exhibits a higher viscosity than a polymer solution obtained by using a azo-based compound in the initial stage of the polymerization. It is thought that the intertwining of the branched portions introduced into the polymer causes the increase in the viscosity of the polymer solution.

Specifically, the polymer is preferably obtained by using a peroxide as a first polymerization initiator and conducting polymerization of the radical polymerizable monomer until a polymerization ratio of 70 to 90% is reached, and subsequently using a second polymerization initiator and continuing the polymerization until the polymerization ratio reaches 99% or higher.

The polymerization ratio is also referred to as the conversion ratio, and can be determined by measuring the weight of the solid fraction (the non-volatile component) within the polymer. In other words, whereas the monomer will volatilize upon heating, this volatile component disappears as the polymerization progresses. Because the monomer concentration used in the polymerization reaction is known, the weight of monomer that originally existed within a solution sample extracted during the polymerization can be calculated. By measuring the weight of the non-volatile fraction within the solution sample extracted during the polymerization, and determining the ratio of this weight relative to the weight of monomer that originally existed within the sample, the proportion of monomer that has undergone polymerization, namely the polymerization ratio, can be determined.

If a peroxide is used in the initial stage of the polymerization, then the quantity of peroxide used is preferably within a range from 0.02 to 0.13 mols, and even more preferably from 0.03 to 0.1 mols, per 100 mols of the radical polymerizable monomer. If this quantity is less than 0.02 mols, then the polymerization does not proceed rapidly enough, whereas if the quantity exceeds 0.13 mols, then the reaction becomes overly fast, the molecular weight decreases, and the reaction may run out of control and become dangerous.

Once the polymerization ratio has reached 70 to 90%, a second polymerization initiator is preferably used to further react the residual radical polymerizable monomer. The combined quantity of the first polymerization initiator and the second polymerization initiator is preferably within a range from 0.05 to 1 mol, and even more preferably from 0.07 to 0.7 mols, per 100 mols of the radical polymerizable monomer.

From the viewpoint of increasing the cohesive force of the pressure-sensitive adhesive layer, the quantity of branched structures within the polymer contained within the pressure-sensitive adhesive is preferably increased. However, if the quantity of branching within the polymer is too large, then the viscosity of the polymer solution or the pressure-sensitive adhesive comprising the polymer solution becomes excessively high.

If the viscosity of the polymer solution is excessively high, then there is a danger that the viscosity may impede operations during the polymerization. In other words, achieving uniform stirring during the polymerization becomes difficult, ensuring uniform temperature control during the polymerization becomes problematic, and extracting the polymer solution from the polymerization tank (the vessel used in the polymerization) following the polymerization also becomes difficult.

In addition, if the viscosity of the pressure-sensitive adhesive comprising the polymer solution is excessively high, then applying the pressure-sensitive adhesive to a sheet-like substrate becomes difficult. A solvent can be added to an overly viscous pressure-sensitive adhesive to reduce the viscosity and improve the coating properties. However, following application of the pressure-sensitive adhesive to a sheet-like substrate, the solvent contained within the pressure-sensitive adhesive must be removed by drying, and therefore for economic and environmental reasons, the quantity of solvent within the pressure-sensitive adhesive is preferably as small as possible.

In other words, the polymer is preferably a branched structure, but the degree of branching is preferably not too high. In order to introduce an “appropriate” degree of branching into the polymer, an aromatic peroxide is preferably used in the initial stage of the polymerization.

Specifically, an aromatic peroxide, and even more specifically benzoyl peroxide, is preferably used as the first polymerization initiator, and polymerization of the radical polymerizable monomer is conducted until a polymerization ratio of 70 to 90% is reached. Subsequently, benzoyl peroxide or t-butyl peroxy-2-ethylhexanoate or the like is preferably used as the second polymerization initiator, and polymerization is continued until the polymerization ratio reaches 99% or higher, thereby yielding the polymer (A).

There are no particular restrictions on the second polymerization initiator, and any of the polymerization initiators listed above can be used.

If the second polymerization initiator is added before the polymerization ratio reaches 70%, then the activity of the first polymerization initiator will usually not have been entirely lost, meaning obtaining a polymer with a weight average molecular weight within a range from 500,000 to 1,500,000 becomes difficult. In contrast, if the second polymerization initiator is added at a stage where the polymerization ratio exceeds 90%, namely, at a point where the polymerization of the radical polymerizable monomer is almost complete, then unused polymerization initiator is left within the polymer solution, which increases the likelihood of a deterioration in the storage stability of the polymer solution.

If a non-aromatic peroxide such as t-butyl peroxy-2-ethylhexanoate is used as the first polymerization initiator, then for a similar molecular weight, the viscosity of the polymer solution or the pressure-sensitive adhesive comprising the polymer solution is approximately 1.4 times greater than the case where an aromatic peroxide is used as the first polymerization initiator. This observation supports the finding that use of a non-aromatic peroxide as the first polymerization initiator yields a polymer with increased branching.

The degree of branching within the polymer (A) can be ascertained indirectly on the basis of the viscosity of the polymer solution. For example, when the polymer (A) is formed as a solution with a solid fraction concentration of 45% using toluene and/or ethyl acetate as the solvent, the viscosity of the solution at 25° C. is preferably within a range from 15,000 to 40,000 mPa·s, and is even more preferably from 17,000 to 30,000 mPa·s.

In the present invention, the initial stage of polymerization refers to the stage up until the point where the polymerization ratio reaches 70 to 90%. The polymerization initiator used during this stage, namely the first polymerization initiator, may be added to the polymerization tank (the vessel used in the polymerization) from the start of the polymerization, or may be added dropwise to the polymerization tank from a dropwise addition tank. The first polymerization initiator may also be added to the polymerization tank as well as being added dropwise from a dropwise addition tank.

Next is a description of the tricyclic diterpene carboxylic acid (B).

Compounds contained within pine resins, such as abietic acids and various derivatives thereof can be used as the tricyclic diterpene carboxylic acid (B). Specific examples include abietic acid, levopimaric acid, neoabietic acid, patastrinic acid, dehydroabietic acid, pimaric acid, isopimaric acid, secodehydroabietic acid, dihydroabietic acid, tetrahydroabietic acid, elliotinoic acid, sandaracopimaric acid, and mixtures thereof; as well as compounds obtained by adding hydrogen to the various compounds above, dimers of the various compounds above, phenolic resins modified with the various compounds above, reaction products of maleic acid and the various compounds above, esterified products of the various compounds above and glycerol, and esterified products of the various compounds above and pentaerythritol.

Of these, dimers of the various compounds above, esterified products of the various compounds above and glycerol, and esterified products of the various compounds above and pentaerythritol are preferred.

These tricyclic diterpene carboxylic acids (B) have a molecular weight within a range from 500 to 10,000, which is markedly smaller than the molecular weight of the polymer (A).

In terms of achieving favorable cohesive force as a pressure-sensitive adhesive and favorable adhesion to adherends, the tricyclic diterpene carboxylic acid (B) preferably has an acid value within a range from 3 to 100 (mgKOH/g), and this value is even more preferably from 7 to 70 (mgKOH/g), and is most preferably from 10 to 50 (mgKOH/g).

If the acid value of the tricyclic diterpene carboxylic acid (B) is extremely large, then there is a danger that the curing agent (C) described below will be completely consumed by reaction with the tricyclic diterpene carboxylic acid (B) and not undergo adequate reaction with the polymer (A). If the level of reaction between the polymer (A) and the curing agent (C) is inadequate, then the cohesive force of the pressure-sensitive adhesive layer is more likely to be insufficient, and the removability is likely to be poor.

In the pressure-sensitive adhesive of the present invention, it is important that both the polymer (A) and the tricyclic diterpene carboxylic acid (B) contain carboxyl groups, and specifically, the total acid value for the combination of the two components is preferably within a range from 5 to 50 (mgKOH/g), even more preferably from 10 to 40 (mgKOH/g), and is most preferably from 20 to 35 (mgKOH/g). This total acid value can be determined from the weight ratio of the two components and the acid values of the two components.

Because both the polymer (A) and the tricyclic diterpene carboxylic acid (B) contain carboxyl groups, both components react with the curing agent (C) described below, enabling the formation of a dense pressure-sensitive adhesive layer with a large cohesive force.

If the total acid value for the polymer (A) and the tricyclic diterpene carboxylic acid (B) is less than 5 (mgKOH/g), then the quantity of functional groups capable of reacting with the curing agent (C) described below is too small. As a result, the cohesive force of the pressure-sensitive adhesive layer decreases dramatically, and a satisfactory holding force cannot be realized. Because the cohesive force is small, if the pressure-sensitive adhesive layer is exposed to high temperatures or conditions of high temperature and high humidity following bonding, then the layer tends to lift or peel away from the adherend. Furthermore, because the cohesive force is small, if the pressure-sensitive adhesive sheet is peeled away from the adherend following bonding, then portions of the pressure-sensitive adhesive layer remain on the adherend, contaminating the adherend.

In contrast, if the total acid value for the polymer (A) and the tricyclic diterpene carboxylic acid (B) exceeds 50 (mgKOH/g), then the quantity of functional groups capable of reacting with the curing agent (C) described below is too large. As a result, the pressure-sensitive adhesive layer becomes overly hard, meaning a satisfactory holding force cannot be realized.

A mixture of the polymer (A) and the tricyclic diterpene carboxylic acid (B) with a total acid value within a range from 5 to 50 (mgKOH/g) can be obtained, for example, by adding from 1 to 50 parts by weight of a tricyclic diterpene carboxylic acid (B) with an acid value of approximately 5 to 100 (mgKOH/g) to 100 parts by weight of a polymer (A) with an acid value of approximately 10 to 50 (mgKOH/g). The quantity added of the tricyclic diterpene carboxylic acid (B) is preferably within a range from 5 to 40 parts by weight, and is even more preferably from 10 to 35 parts by weight.

If the blend quantity of the tricyclic diterpene carboxylic acid (B) relative to 100 parts by weight of the polymer (A) is less than 1 part by weight, then the adhesion of the pressure-sensitive adhesive layer to the adherend or sheet-like substrate tends to be unsatisfactory. In contrast, if the blend quantity of the tricyclic diterpene carboxylic acid (B) exceeds 50 parts by weight, then there is a danger that the compatibility with the polymer (A) deteriorates and the pressure-sensitive adhesive may develop white cloudiness. Moreover, compared with the polymer (A), the reactivity of the tricyclic diterpene carboxylic acid (B) with the curing agent is relatively low, and consequently if the quantity of the tricyclic diterpene carboxylic acid (B) is too large, then the proportion of residual component (B) that has not reacted with the curing agent (C) increases. As a result, this unreacted tricyclic diterpene carboxylic acid (B) migrates from the pressure-sensitive adhesive layer onto the adherend, and is likely to remain on the adherend surface.

By using a tricyclic diterpene carboxylic acid (B) such as abietic acid or a derivative thereof, the adhesion to the adherend or sheet-like substrate can be improved. It is thought that the reason for this observation is that a suitable quantity of the tricyclic diterpene carboxylic acid (B) becomes incorporated within the intertwined polymer chains of the high molecular weight polymer (A), thereby lowering the crystallinity of the polymer (A), and enabling the adhesion to be increased with favorable retention of the cohesive force. Of course, even without the tricyclic diterpene carboxylic acid (B), the pressure-sensitive adhesive exhibits a certain degree of adhesion, but this adhesion is inadequate for applications such as optical members and the like, which require heat resistance and humidity resistance.

In the present invention, a compound that is capable of reacting with a carboxyl group is used as the curing agent (C).

Isocyanate-based curing agents are representative examples of curing agents that are capable of reacting with a hydroxyl group. Isocyanate-based curing agents exhibit excellent reactivity with hydroxyl groups, and readily generate a large cohesive force within the pressure-sensitive adhesive layer, and are consequently preferred.

However, isocyanate-based curing agents not only react with the hydroxyl groups of the polymer that represents the main component within the pressure-sensitive adhesive, but also react readily with moisture contained within the pressure-sensitive adhesive or moisture in the air. Accordingly, in order to ensure favorable reproducibility of the various performance factors of a pressure-sensitive adhesive sheet formed from a pressure-sensitive adhesive that uses an isocyanate-based curing agent, the conditions and surrounding environment must be precisely controlled during application and drying.

In contrast, pressure-sensitive adhesives that utilize the reaction between carboxyl groups and a curing agent capable of reacting with a carboxyl group are much less likely to be affected by fluctuations in the conditions or changes in the surrounding environment during application and drying, and therefore ensure excellent reproducibility of the various performance factors of a pressure-sensitive adhesive sheet.

Accordingly, in the present invention, this reaction with carboxyl groups was utilized, and a configuration was adopted in which the polymer (A) comprising carboxyl groups and the tricyclic diterpene carboxylic acid (B) are combined with a curing agent (C) capable of reacting with a carboxyl group.

Examples of compounds that can be used as this curing agent (C) include metal chelate-based curing agents, epoxy-based curing agents, isocyanate-based curing agents, and aziridine-based curing agents. Any of these compounds may be used alone, or a plurality of different compounds may be used in combination.

The quantity of the curing agent (C) is preferably within a range from 0.01 to 10 parts by weight per 100 parts by weight of the combination of the polymer (A) and the tricyclic diterpene carboxylic acid (B). This quantity is even more preferably within a range from 0.25 to 5 parts by weight. If the quantity is less than 0.01 parts by weight, then there is a danger that the cohesive force will be insufficient for a pressure-sensitive adhesive layer, whereas if the quantity exceeds 10 parts by weight, the adhesion to the adherend is more likely to be unsatisfactory.

Of the various curing agents (C), in terms of the heat resistance, heat and humidity resistance, removability, and high cohesive force of the resulting pressure-sensitive adhesive sheet, metal chelate-based curing agents are preferred. The reaction between a metal chelate-based curing agent and a carboxyl group is a coordination bond-forming reaction, and therefore proceeds more rapidly than covalent bond-generating reactions. The carboxyl group within the tricyclic diterpene carboxylic acid (B) has a much greater degree of steric hindrance than the carboxyl groups within the polymer (A), and therefore reacts less readily than the carboxyl groups within the polymer (A). Accordingly, using a metal chelate-based curing agent with excellent reactivity is preferred, as it enables not only the polymer (A), but also the tricyclic diterpene carboxylic acid (B) to contribute actively to the curing reaction, thereby yielding a high level of cohesive force.

Examples of metal chelate-based curing agents include titanium chelate curing agents, aluminum chelate curing agents, and zirconium chelate curing agents. If a titanium chelate curing agent is used, then the pressure-sensitive adhesive is prone to coloration and loss of transparency. In a zirconium chelate curing agent, because the atomic radius of zirconium is large, the binding force tends to weaken. Accordingly, an aluminum chelate-based curing agent, which does not suffer from these types of problems, is preferred.

An aluminum chelate-based curing agent is also preferred in terms of the stability and ease of handling of the metal chelate-based curing agent. Because aluminum chelate-based curing agents often contain a chelate structure between a compound such as a β-diketone and aluminum, the pressure-sensitive adhesive can be maintained in a stable state even after addition of the curing agent.

There are no particular restrictions on the epoxy-base curing agent, provided the compound contains a plurality of epoxy groups within each molecule. Specific examples include ethylene glycol diglycidyl ether, polyethylene glycol diglycidyl ether, 1,6-hexanediol diglycidyl ether, bisphenol A-epichlorohydrin type epoxy resins, N,N,N′,N′-tetraglycidyl-m-xylenediamine, 1,3-bis(N,N-diglycidylaminomethyl)cyclohexane, N,N-diglycidylaniline, and N,N-diglycidyltoluidine.

Examples of compounds that can be used as the isocyanate-based curing agent include diisocyanate compounds, so-called adducts obtained by modifying a diisocyanate compound with a trifunctional polyol component, biurets obtained by reacting a diisocyanate compound with water, and trimers containing an isocyanurate ring (isocyanurates) formed from three molecules of a diisocyanate compound.

Examples of diisocyanate compounds include aromatic diisocyanates, aliphatic diisocyanates, aromatic-aliphatic diisocyanates, and alicyclic diisocyanates.

Examples of aromatic diisocyanates include 1,3-phenylene diisocyanate, 4,4′-diphenyl diisocyanate, 1,4-phenylene diisocyanate, 4,4′-diphenylmethane diisocyanate, 2,4-tolylene diisocyanate, 2,6-tolylene diisocyanate, 4,4′-toluidine diisocyanate, dianisidine diisocyanate, and 4,4′-diphenyl ether diisocyanate.

Examples of aliphatic diisocyanates include trimethylene diisocyanate, tetramethylene diisocyanate, hexamethylene diisocyanate, pentamethylene diisocyanate, 1,2-propylene diisocyanate, 2,3-butylene diisocyanate, 1,3-butylene diisocyanate, dodecamethylene diisocyanate, and 2,4,4-trimethylhexamethylene diisocyanate.

Examples of aromatic-aliphatic diisocyanates include ω,ω′-diisocyanato-1,3-dimethylbenzene, ω,ω′-diisocyanato-1,4-dimethylbenzene, ω,ω′-diisocyanato-1,4-diethylbenzene, 1,4-tetramethylxylylene diisocyanate, and 1,3-tetramethylxylylene diisocyanate.

Examples of alicyclic diisocyanates include 3-isocyanatomethyl-3,5,5-trimethylcyclohexyl isocyanate, 1,3-cyclopentane diisocyanate, 1,3-cyclohexane diisocyanate, 1,4-cyclohexane diisocyanate, methyl-2,4-cyclohexane diisocyanate, methyl-2,6-cyclohexane diisocyanate, 4,4′-methylenebis(cyclohexyl isocyanate), 1,4-bis(isocyanatomethyl)cyclohexane, and 1,4-bis(isocyanatomethyl)cyclohexane.

Of the compounds listed above, 2,4-tolylene diisocyanate, hexamethylene diisocyanate, and 3-isocyanatomethyl-3,5,5-trimethylcyclohexyl isocyanate (isophorone diisocyanate) are preferred as the diisocyanate compound.

Furthermore, adducts, biurets, and isocyanurates of these diisocyanate compounds can also be used favorably.

Aziridine-based curing agents are compounds containing at least two aziridinyl groups within each molecule, and examples include tri-1-aziridinyl phosphine oxide, N,N′-hexamethylene-1,6-bis(1-aziridinecarboxyamide), N,N′-diphenylethane-4,4′-bis(1-aziridinecarboxyamide), trimethylolpropane-tri-β-aziridinylpropionate, N,N′-toluene-2,4-bis(aziridinecarboxyamide), bisisophthaloyl-1-(2-methylaziridine) phosphine, and trimethylolpropane-tri-β-(2-methylaziridine)propionate.

The pressure-sensitive adhesive can be produced by mixing the polymer (A), a sufficient quantity of the tricyclic diterpene carboxylic acid (B) to generate a total acid value for the combination with the polymer (A) that is within a range from 5 to 50 (mgKOH/g), and the curing agent (C) containing a functional group capable of reacting with a carboxyl group. For example, the tricyclic diterpene carboxylic acid (B) may be added to the polymer (A), and the curing agent (C) then added.

Besides the components (A), (B) and (C) described above, the pressure-sensitive adhesive may also include various resins, coupling agents, softening agents, dyes, pigments, antioxidants, ultraviolet absorbers, weather resistance stabilizers, adhesion-imparting agents, plasticizers, fillers and age resistors, provided these other components do not impair the effects of the present invention.

Using the pressure-sensitive adhesive of the present invention, a laminated product formed from a pressure-sensitive adhesive layer and a sheet-like substrate, namely, a pressure-sensitive adhesive sheet comprising a sheet-like substrate, and a pressure-sensitive adhesive layer, which is formed from the pressure-sensitive adhesive of the present invention and is laminated to at least one surface of the sheet-like substrate, can be produced.

Examples of the sheet-like substrate include flat substrates formed from cellophane, various plastic sheets, rubbers, foamed items, fabrics, rubber-coated fabrics (fabrics comprising a rubber surface layer), resin-impregnated fabrics, glass plates, metal sheets and wood. Furthermore, the various substrates may be either single layer substrates, or substrates with multilayered structures prepared by laminating a plurality of layers. Moreover, substrates that have undergone surface release treatments may also be used.

The various plastic sheets are also referred to as plastic films, and examples include polyvinyl alcohol films, triacetyl cellulose films, polyolefin-based resin films such as polypropylene, polyethylene, polycycloolefins, and ethylene-vinyl acetate copolymers; polyester-based resin films such as polyethylene terephthalate and polybutylene terephthalate; as well as films of polycarbonate-based resins, films of polynorbornene-based resins, films of polyallylate-based resins, films of acrylic resins, films of polyphenylene sulfide resins, films of polystyrene resins, films of vinyl-based resins, films of polyamide-based resins, films of polyimide-based resins, and films of epoxy-based resins.

A pressure-sensitive adhesive according to the present invention can be used favorably within optical applications, and when a pressure-sensitive adhesive sheet is used within the optical field, the above plastic film is preferably an optical plastic film with a total light transmittance of at least 80% for a film of thickness 100 μm.

The use of a polyester film, polycarbonate film, triacetate film, cycloolefin film or acrylic film as this optical plastic film is preferred.

The optical plastic film may use either a single layered film or a multilayered film.

The use of a polyester film, polycarbonate film, triacetate film or cycloolefin film is preferred for a single layered optical film.

Examples of multilayered optical films include polarization films, phase difference films, elliptical polarization films, antireflective films, and brightness-enhancing films. Examples of polarization films include multilayered structures in which the two surfaces of a polyvinyl alcohol-based polarizer are sandwiched between triacetyl cellulose-based protective films (hereafter referred to as TAC films). Examples of phase difference films include multilayered films in which a stretched polycarbonate film is laminated to a polarization film described above. Examples of antireflective films include multilayered films in which poly-4-ethylene fluoride is coated onto polyethylene terephthalate. Examples of brightness-enhancing films include multilayered films in which diffusive fine organic particles are coated onto polyethylene terephthalate.

A pressure-sensitive adhesive of the present invention comprises a tricyclic diterpene carboxylic acid (B) and exhibits a high degree of adhesion to a variety of sheet-like substrates, and can therefore be used favorably not only for optical plastic films, but also for sheet-like substrates such as foamed items that are generally considered to be difficult to bond.

The pressure-sensitive adhesive sheet can be obtained, for example, by using an appropriate method to apply the pressure-sensitive adhesive to any of a variety of sheet-like substrates, and then conducting drying and curing.

For the coating process, an organic solvent such as ethyl acetate, toluene, isopropyl alcohol, or another hydrocarbon-based solvent may also be added to the pressure-sensitive adhesive to adjust the viscosity, or the pressure-sensitive adhesive may also be heated to lower the viscosity.

A pressure-sensitive adhesive layer can be formed on top of the sheet-like substrate either by removing the liquid medium from the applied pressure-sensitive adhesive layer in those cases where the pressure-sensitive adhesive includes a liquid medium such as an organic solvent or water, or by cooling and solidifying the melted pressure-sensitive adhesive layer in those cases where the pressure-sensitive adhesive contains no liquid medium that requires volatilization.

Application of the pressure-sensitive adhesive can be conducted using any of a variety of techniques or devices, including a Myer bar, applicator, brush, sprayer, roller, gravure coater, die coater, lip coater, comma coater, knife coater, reverse coater or spin coater.

There are no particular restrictions on the drying method used, and suitable methods include those that use hot air drying, infrared drying, or reduced pressure methods. Although the drying conditions will vary depending on the curing configuration of the pressure-sensitive adhesive, the film thickness and the selected solvent, conducting drying by hot air drying at a temperature of 60 to 180° C. is generally preferred.

For example, by applying the pressure-sensitive adhesive to the release-treated surface of a release-treated sheet-like substrate, drying the adhesive, and then laminating a sheet-like substrate that has not undergone release treatment to the surface of the pressure-sensitive adhesive layer, a single-sided pressure-sensitive adhesive sheet can be obtained.

Alternatively, by applying the pressure-sensitive adhesive to a sheet-like substrate that has not undergone release treatment, drying the adhesive, and then laminating the release-treated surface of a release-treated sheet-like substrate to the surface of the pressure-sensitive adhesive layer, a single-sided pressure-sensitive adhesive sheet can be obtained.

Moreover, by applying the pressure-sensitive adhesive to the release-treated surface of a release-treated sheet-like substrate, drying the adhesive, and then laminating the release-treated surface of another release-treated sheet-like substrate to the surface of the pressure-sensitive adhesive layer, a double-sided pressure-sensitive adhesive sheet can be obtained.

For example, in the case of the bonding of a polarization film to a glass member of a liquid crystal cell, a single-sided pressure-sensitive adhesive sheet that uses a polarization film as the sheet-like substrate is prepared. By peeling the release-treated sheet-like substrate that covers the surface of the pressure-sensitive adhesive layer away from this single-sided pressure-sensitive adhesive sheet, and then bonding the pressure-sensitive adhesive layer to the liquid crystal cell glass member, a liquid crystal cell member with a configuration represented by polarization film/pressure-sensitive adhesive layer/liquid crystal cell glass member can be obtained.

The thickness of the pressure-sensitive adhesive layer is preferably within a range from 0.1 to 200 μm, and is even more preferably from 1 to 100 μm. At values of 0.1 μm or less, satisfactory adhesive strength may be unobtainable, whereas properties such as the adhesive strength often show no further improvement even if the thickness is increased beyond 200 μm.

### EXAMPLES

As follows is a description of specific examples and comparative examples of the present invention, although the present invention is in no way limited by the examples presented below. In the following examples and comparative examples, “parts” and “%” refer to “parts by weight” and “% by weight” respectively.

### Synthesis Example 1

[Polymerization tank]

| | | |
|---|---|---|
| 2-ethylhexyl acrylate | 3.0 | parts |
| butyl acrylate | 8.0 | parts |
| ethyl acrylate | 2.5 | parts |
| acrylic acid | 0.4 | parts |
| ethyl acetate | 16.0 | parts |
| benzoyl peroxide | 0.01 | parts |

[Dropwise addition device]

| | | |
|---|---|---|
| 2-ethylhexyl acrylate | 5.5 | parts |
| butyl acrylate | 16.0 | parts |
| acrylic acid | 0.8 | parts |
| ethyl acetate | 6.3 | parts |
| toluene | 6.5 | parts |
| benzoyl peroxide | 0.02 | parts |

Following replacement of the air inside the polymerization tank with nitrogen gas, and under constant stirring, dropwise addition from the dropwise addition device was commenced under a nitrogen atmosphere and at the reflux temperature. Following completion of the dropwise addition, stirring was continued, and when the polymerization conversion rate reached 82%, 0.04 parts of benzoyl peroxide and 0.03 parts of t-butyl peroxy-2-ethylhexanoate were added, and the reaction was then continued for 3 hours, until the polymerization conversion rate reached at least 99%.

Subsequently, 16 parts of ethyl acetate was added, and the reaction mixture was cooled to room temperature, thereby halting the reaction.

### Synthesis Example 2

[Polymerization tank]

| | | |
|---|---|---|
| 2-ethylhexyl acrylate | 3.0 | parts |
| butyl acrylate | 8.0 | parts |
| ethyl acrylate | 2.5 | parts |
| acrylic acid | 0.4 | parts |
| ethyl acetate | 16.0 | parts |
| benzoyl peroxide | 0.01 | parts |

[Dropwise addition device]

| | | |
|---|---|---|
| 2-ethylhexyl acrylate | 5.5 | parts |
| butyl acrylate | 16.0 | parts |
| acrylic acid | 0.8 | parts |
| 2-hydroxyethyl acrylate | 0.03 | parts |
| ethyl acetate | 6.3 | parts |
| toluene | 6.5 | parts |
| benzoyl peroxide | 0.02 | parts |

Polymerization was conducted in the same manner as the synthesis example 1, and when the polymerization conversion rate reached 83%, 0.04 parts of benzoyl peroxide and 0.03 parts of t-butyl peroxy-2-ethylhexanoate were added, and the reaction was then continued for 3 hours, until the polymerization conversion rate reached at least 99%.

Subsequently, 16 parts of ethyl acetate was added, and the reaction mixture was cooled to room temperature, thereby halting the reaction.

### Synthesis Example 3

[Polymerization tank]

| | | |
|---|---|---|
| 2-ethylhexyl acrylate | 4.1 | parts |
| butyl acrylate | 6.5 | parts |
| methyl acrylate | 1.2 | parts |
| methyl methacrylate | 5.4 | parts |
| acrylic acid | 0.5 | parts |
| ethyl acetate | 16.0 | parts |
| benzoyl peroxide | 0.01 | parts |

[Dropwise addition device]

| | | |
|---|---|---|
| 2-ethylhexyl acrylate | 4.1 | parts |
| butyl acrylate | 6.5 | parts |
| methyl acrylate | 1.2 | parts |
| methyl methacrylate | 5.4 | parts |
| 2-hydroxyethyl acrylate | 0.03 | parts |
| acrylic acid | 0.6 | parts |
| ethyl acetate | 6.3 | parts |
| toluene | 6.5 | parts |
| benzoyl peroxide | 0.02 | parts |

Polymerization was conducted in the same manner as the synthesis example 1, and when the polymerization conversion rate reached 80%, 0.04 parts of benzoyl peroxide and 0.03 parts of t-butyl peroxy-2-ethylhexanoate were added, and the reaction was then continued for 3 hours, until the polymerization conversion rate reached at least 99%.

Subsequently, 16 parts of ethyl acetate was added, and the reaction mixture was cooled to room temperature, thereby halting the reaction.

### Synthesis Example 4

[Polymerization tank]

| | | |
|---|---|---|
| 2-ethylhexyl acrylate | 3.0 | parts |
| butyl acrylate | 8.0 | parts |
| ethyl acrylate | 2.5 | parts |
| acrylic acid | 0.4 | parts |
| ethyl acetate | 16.0 | parts |
| benzoyl peroxide | 0.03 | parts |

[Dropwise addition device]

| | | |
|---|---|---|
| 2-ethylhexyl acrylate | 5.5 | parts |
| butyl acrylate | 16.0 | parts |
| acrylic acid | 0.8 | parts |
| 2-hydroxyethyl acrylate | 0.03 | parts |
| ethyl acetate | 6.3 | parts |
| toluene | 6.5 | parts |
| benzoyl peroxide | 0.06 | parts |

Polymerization was conducted in the same manner as the synthesis example 1, and when the polymerization conversion rate reached 85%, 0.04 parts of benzoyl peroxide and 0.03 parts of t-butyl peroxy-2-ethylhexanoate were added, and the reaction was then continued for 3 hours, until the polymerization conversion rate reached at least 99%.

Subsequently, 16 parts of ethyl acetate was added, and the reaction mixture was cooled to room temperature, thereby halting the reaction.

### Synthesis Example 5

[Polymerization tank]

| | | |
|---|---|---|
| 2-ethylhexyl acrylate | 8.5 | parts |
| butyl acrylate | 24.0 | parts |
| ethyl acrylate | 2.5 | parts |
| acrylic acid | 1.2 | parts |
| acetone | 28.8 | parts |
| 2,2′-azobisisobutyronitrile | 0.01 | parts |

Following replacement of the air inside the polymerization tank with nitrogen gas, and under constant stirring, reaction was commenced under a nitrogen atmosphere and at the reflux temperature. Stirring was continued, and when the polymerization conversion rate reached 78%, 0.02 parts of 2,2′-azobisisobutyronitrile was added, and the reaction was then continued for 4 hours.

Subsequently, 16 parts of ethyl acetate was added, and the reaction mixture was cooled to room temperature, thereby halting the reaction.

### Synthesis Example 6

[Polymerization tank]

| | | |
|---|---|---|
| 2-ethylhexyl acrylate | 3.0 | parts |
| butyl acrylate | 8.0 | parts |
| ethyl acrylate | 2.5 | parts |
| acrylic acid | 0.4 | parts |
| ethyl acetate | 16.0 | parts |
| t-butyl peroxy-2-ethylhexanoate | 0.009 | parts |

[Dropwise addition device]

| | | |
|---|---|---|
| 2-ethylhexyl acrylate | 5.5 | parts |
| butyl acrylate | 16.0 | parts |
| acrylic acid | 0.8 | parts |
| ethyl acetate | 6.3 | parts |
| toluene | 6.5 | parts |
| t-butyl peroxy-2-ethylhexanoate | 0.018 | parts |

Polymerization was conducted in the same manner as the synthesis example 1, and when the polymerization conversion rate reached 81%, 0.04 parts of benzoyl peroxide and 0.03 parts of t-butyl peroxy-2-ethylhexanoate were added, and the reaction was then continued for 3 hours, until the polymerization conversion rate reached at least 99%.

Subsequently, 16 parts of ethyl acetate was added, and the reaction mixture was cooled to room temperature, thereby halting the reaction.

### Synthesis Example 7

[Polymerization tank]

| | | |
|---|---|---|
| 2-ethylhexyl acrylate | 3.0 | parts |
| butyl acrylate | 8.0 | parts |
| ethyl acrylate | 2.5 | parts |
| acrylic acid | 0.4 | parts |
| ethyl acetate | 16.0 | parts |
| benzoyl peroxide | 0.01 | parts |

[Dropwise addition device]

| | | |
|---|---|---|
| 2-ethylhexyl acrylate | 5.5 | parts |
| butyl acrylate | 16.0 | parts |
| acrylic acid | 0.8 | parts |
| ethyl acetate | 6.3 | parts |
| toluene | 6.5 | parts |
| benzoyl peroxide | 0.02 | parts |

Polymerization was conducted in the same manner as the synthesis example 1, and when the polymerization conversion rate reached 80%, 0.05 parts of 2,2′-azobisisobutyronitrile was added, and the reaction was then continued for 3 hours, until the polymerization conversion rate reached at least 99%.

Subsequently, 16 parts of ethyl acetate was added, and the reaction mixture was cooled to room temperature, thereby halting the reaction.

### Synthesis Example 8

[Polymerization tank]

| | | |
|---|---|---|
| 2-ethylhexyl acrylate | 3.4 | parts |
| butyl acrylate | 8.0 | parts |
| ethyl acrylate | 2.5 | parts |
| ethyl acetate | 16.0 | parts |
| benzoyl peroxide | 0.01 | parts |

[Dropwise addition device]

| | | |
|---|---|---|
| 2-ethylhexyl acrylate | 6.3 | parts |
| butyl acrylate | 16.0 | parts |
| 2-hydroxyethyl acrylate | 0.03 | parts |
| ethyl acetate | 6.3 | parts |
| toluene | 6.5 | parts |
| benzoyl peroxide | 0.02 | parts |

Polymerization was conducted in the same manner as the synthesis example 1, and when the polymerization conversion rate reached 82%, 0.04 parts of benzoyl peroxide and 0.03 parts of t-butyl peroxy-2-ethylhexanoate were added, and the reaction was then continued for 3 hours, until the polymerization conversion rate reached at least 99%.

Subsequently, 16 parts of ethyl acetate was added, and the reaction mixture was cooled to room temperature, thereby halting the reaction.

### Synthesis Example 9

[Polymerization tank]

| | | |
|---|---|---|
| 2-ethylhexyl acrylate | 3.0 | parts |
| butyl acrylate | 6.4 | parts |
| ethyl acrylate | 2.5 | parts |
| acrylic acid | 2.0 | parts |
| ethyl acetate | 16.0 | parts |
| benzoyl peroxide | 0.01 | parts |

[Dropwise addition device]

| | | |
|---|---|---|
| 2-ethylhexyl acrylate | 5.5 | parts |
| butyl acrylate | 14.8 | parts |
| acrylic acid | 2.0 | parts |
| 2-hydroxyethyl acrylate | 0.03 | parts |
| ethyl acetate | 6.3 | parts |
| toluene | 6.5 | parts |
| benzoyl peroxide | 0.02 | parts |

Polymerization was conducted in the same manner as the synthesis example 1, and when the polymerization conversion rate reached 85%, 0.04 parts of benzoyl peroxide and 0.03 parts of t-butyl peroxy-2-ethylhexanoate were added, and the reaction was then continued for 3 hours, until the polymerization conversion rate reached at least 99%.

Subsequently, 16 parts of ethyl acetate was added, and the reaction mixture was cooled to room temperature, thereby halting the reaction.

### Synthesis Example 10

[Polymerization tank]

| | | |
|---|---|---|
| 2-ethylhexyl acrylate | 3.0 | parts |
| butyl acrylate | 8.0 | parts |
| ethyl acrylate | 2.5 | parts |
| acrylic acid | 0.4 | parts |
| ethyl acetate | 16.0 | parts |
| 2,2′-azobisisobutyronitrile | 0.007 | parts |

[Dropwise addition device]

| | | |
|---|---|---|
| 2-ethylhexyl acrylate | 5.5 | parts |
| butyl acrylate | 16.0 | parts |
| acrylic acid | 0.8 | parts |
| 2-hydroxyethyl acrylate | 0.03 | parts |
| ethyl acetate | 6.3 | parts |
| toluene | 6.5 | parts |
| 2,2′-azobisisobutyronitrile | 0.0013 | parts |

Polymerization was conducted in the same manner as the synthesis example 1, and when the polymerization conversion rate reached 85%, 0.04 parts of benzoyl peroxide and 0.03 parts of t-butyl peroxy-2-ethylhexanoate were added, and the reaction was then continued for 3 hours, until the polymerization conversion rate reached at least 99%.

Subsequently, 16 parts of ethyl acetate was added, and the reaction mixture was cooled to room temperature, thereby halting the reaction.

Each of the reaction solutions obtained in the synthesis examples 1 through 10 were evaluated for external appearance, non-volatile fraction (the solid fraction) and viscosity, and the weight average molecular weight (Mw), Tg and acid value were also determined for the copolymer, using the methods described below.

### <Solution External Appearance>

The external appearance of each of the reaction solutions was evaluated visually.

### <Measurement of the Non-Volatile Fraction>

Approximately 1 g of each reaction solution was weighed into a metal container, the container was heated for 20 minutes in a 150° C. oven, the residue was weighed, and the residue ratio was then calculated and used as the non-volatile fraction (the solid fraction).

### <Measurement of Solution Viscosity>

The viscosity of each reaction solution was measured at 25° C. using a B-type viscometer (manufactured by Tokyo Keiki Kogyo Co., Ltd.), under conditions including 12 rpm and revolution for 1 minute.

### <Measurement of Weight Average Molecular Weight (Mw) and the Like>

Measurement of Mw was conducted using a GPC (gel permeation chromatography device; HPC-8020) manufactured by Tosoh Corporation. GPC is a liquid chromatography in which a substance dissolved in a solvent (THF; tetrahydrofuran) is separated and quantified based on differences in the molecular size, and determination of the weight average molecular weight (Mw) was conducted by comparison with polystyrene standards. Moreover, integrated values (from the GPC chart area) were used to calculate the area % for molecular weights of 2,000,000 or higher.

### <Tg for Copolymer>

The Tg value for each copolymer was determined from the monomer composition.

### <Acid Value for Copolymer>

The weight % of acrylic acid relative to the combined weight of all the monomers that constitute the copolymer was termed [A], and by using 72.1 for the molecular weight of acrylic acid and 56.11 for the molecular weight of potassium hydroxide, the acid value was determined using the formula shown below.

Copolymer acid value=([A]×56.11×1,000)/(100×72.1)

TABLE 1

| | | | | Weight | Molecular | | |
|---|---|---|---|---|---|---|---|
| | Solution | Solid | | average | weight of | | |
| | external | fraction | Viscosity | molecular | 2,000,000 or | | Acid value |
| | appearance | (%) | (mPa · s) | weight (Mw) | greater (%) | Tg (° C.) | (mgKOH/g) |
| Synthesis | Colorless, | 45 | 25,500 | 650,000 | 7.2 | −44 | 25.8 |
| example 1 | transparent | | | | | | |
| Synthesis | Colorless, | 45 | 27,000 | 680,000 | 7.6 | −44 | 25.8 |
| example 2 | transparent | | | | | | |
| Synthesis | Colorless, | 45 | 55,000 | 550,000 | 6.2 | 15 | 24.1 |
| example 3 | transparent | | | | | | |
| Synthesis | Colorless, | 45 | 15,000 | 400,000 | 1.5 | −44 | 25.7 |
| example 4 | transparent | | | | | | |
| Synthesis | Colorless, | 45 | 40,000 | 1,800,000 | 16.5 | −44 | 25.8 |
| example 5 | transparent | | | | | | |
| Synthesis | Colorless, | 45 | 38,000 | 800,000 | 9.6 | −44 | 25.8 |
| example 6 | transparent | | | | | | |
| Synthesis | Colorless, | 45 | 18,000 | 550,000 | 6.8 | −44 | 25.8 |
| example 7 | transparent | | | | | | |
| Synthesis | Colorless, | 45 | 20,000 | 630,000 | 6.0 | −54 | 0.0 |
| example 8 | transparent | | | | | | |
| Synthesis | Colorless, | 45 | 30,000 | 720,000 | 7.6 | −23 | 85.9 |
| example 9 | transparent | | | | | | |
| Synthesis | Colorless, | 45 | 8,500 | 450,000 | 2.9 | −44 | 25.7 |
| example 10 | transparent | | | | | | |

### Example 1

To a solution containing 100 g of the copolymer obtained in the synthesis example 1 were added 25 g of Pensel D-125 (a dimer of an esterified product of a tricyclic diterpene carboxylic acid comprising abietic acid as the primary component, acid value: 13.0, manufactured by Arakawa Chemical Industries, Ltd.) and 0.56 g of Alumichelate A (an aluminum chelate-based curing agent, acetoalkoxyaluminum diisopropylate, manufactured by Kawaken Fine Chemicals Co., Ltd.), and the resulting mixture was stirred thoroughly, yielding a pressure-sensitive adhesive. The combined acid value for the copolymer from the synthesis example 1 and the Pensel D-125 contained within the pressure-sensitive adhesive was 23.2 (mgKOH/g).

This pressure-sensitive adhesive was applied to a release-treated polyester film (hereafter referred to as a release film), and dried at 100° C. for 2 minutes, thus forming a pressure-sensitive adhesive layer with a thickness of 25 μm on top of the release film.

One surface of a polarization film having a multilayer structure in which both surfaces of a polyvinyl alcohol-based polarizer had been sandwiched between triacetyl cellulose-based protective films (hereafter referred to as TAC films) was brought into contact with the pressure-sensitive adhesive layer, aging (a dark reaction) was conducted for one week under conditions including a temperature of 23° C. and a relative humidity of 50%, thereby causing the reaction of the pressure-sensitive adhesive layer to proceed and generating a laminated, pressure-sensitive adhesive-treated polarization film having a release film/pressure-sensitive adhesive layer/TAC film/PVA/TAC film structure, namely, a pressure-sensitive adhesive sheet.

### Example 2

With the exceptions of using the copolymer solution obtained in the synthesis example 2 instead of the copolymer solution obtained in the synthesis example 1, and using 25 g of Pensel AZ (an esterified product of a tricyclic diterpene carboxylic acid comprising abietic acid as the primary component, acid value: 43.0, manufactured by Arakawa Chemical Industries, Ltd.) instead of the Pensel D-125, a pressure-sensitive adhesive-treated polarization film, namely a pressure-sensitive adhesive sheet, was prepared in the same manner as the example 1.

### Example 3

With the exception of using the copolymer solution obtained in the synthesis example 2 instead of the copolymer solution obtained in the synthesis example 1, a pressure-sensitive adhesive-treated polarization film, namely a pressure-sensitive adhesive sheet, was prepared in the same manner as the example 1.

### Example 4

With the exception of using the copolymer solution obtained in the synthesis example 6 instead of the copolymer solution obtained in the synthesis example 1, a pressure-sensitive adhesive-treated polarization film, namely a pressure-sensitive adhesive sheet, was prepared in the same manner as the example 1. Because the copolymer solution obtained in the synthesis example 6 had a high viscosity and was difficult to handle, the copolymer solution was diluted with 100 g of toluene prior to preparation of the pressure-sensitive adhesive layer. The pressure-sensitive adhesive layer can be used in this state, but because it employs a diluent solvent that is removed upon drying, the layer is uneconomic.

### Example 5

With the exception of using the copolymer solution obtained in the synthesis example 7 instead of the copolymer solution obtained in the synthesis example 1, a pressure-sensitive adhesive-treated polarization film, namely a pressure-sensitive adhesive sheet, was prepared in the same manner as the example 1

### Example 6

With the exception of using 0.5 g of Orgatix TC-100 (a titanium chelate-based curing agent; titanium acetylacetonate, manufactured by Matsumoto Pharmaceutical Manufacture Co., Ltd.) instead of the Alumichelate A, a pressure-sensitive adhesive-treated polarization film, namely a pressure-sensitive adhesive sheet, was prepared in the same manner as the example 1.

### Example 7

Using the copolymer solution obtained in the synthesis example 1 in the same manner as in the example 1, but with the exception of laminating the pressure-sensitive adhesive layer to a sheet of polyurethane foam to generate a release film/pressure-sensitive adhesive layer/polyurethane foam structure, a pressure-sensitive adhesive sheet was prepared in the same manner as the example 1.

### Example 8

With the exceptions of using the copolymer resin solution obtained in the synthesis example 2 instead of the copolymer resin solution obtained in the synthesis example 1, and using 0.75 g of a tolylene diisocyanate trimethylolpropane adduct instead of the Alumichelate A, a pressure-sensitive adhesive-treated polarization film, namely a pressure-sensitive adhesive sheet, was prepared in the same manner as the example 1.

### Example 9

With the exceptions of using the copolymer solution obtained in the synthesis example 2 instead of the copolymer solution obtained in the synthesis example 1, and using 3.0 g of the Alumichelate A, a pressure-sensitive adhesive-treated polarization film, namely a pressure-sensitive adhesive sheet, was prepared in the same manner as the example 1.

### Comparative Examples 1 to 5

As shown in Table 2, with the exception of using each of the copolymer solutions obtained in the synthesis examples 8, 9, 4, 5 and 10 respectively instead of the copolymer solution obtained in the synthesis example 1, pressure-sensitive adhesive-treated polarization films, namely pressure-sensitive adhesive sheets, were prepared in the same manner as the example 1.

### Comparative Example 6

With the exception of not using the Alumichelate A, a pressure-sensitive adhesive-treated polarization film, namely a pressure-sensitive adhesive sheet, was prepared in the same manner as the example 1.

### Comparative Example 7

With the exceptions of using the copolymer solution obtained in the synthesis example 2 instead of the copolymer solution obtained in the synthesis example 1, and not using the Pensel D-125, a pressure-sensitive adhesive-treated polarization film, namely a pressure-sensitive adhesive sheet, was prepared in the same manner as the example 1.

### Comparative Example 8

With the exception of using the copolymer solution obtained in the synthesis example 3 instead of the copolymer solution obtained in the synthesis example 1, a pressure-sensitive adhesive-treated polarization film, namely a pressure-sensitive adhesive sheet, was prepared in the same manner as the example 1.

### Comparative Example 9

With the exception of using 25 g of KR-1840 (a petroleum-based resin, acid value: 0, manufactured by Arakawa Chemical Industries, Ltd.) instead of the Pensel D-125, a pressure-sensitive adhesive-treated polarization film, namely a pressure-sensitive adhesive sheet, was prepared in the same manner as the example 1.

### Comparative Example 10

With the exception of using 25 g of KR-610 (a hydrogen adduct of an esterified product of a tricyclic diterpene carboxylic acid comprising abietic acid as the primary component, acid value: 170, manufactured by Arakawa Chemical Industries, Ltd.) instead of the Pensel D-125, a pressure-sensitive adhesive-treated polarization film, namely a pressure-sensitive adhesive sheet, was prepared in the same manner as the example 1.

The density factor for each pressure-sensitive adhesive layer obtained in the examples and comparative examples was determined using the method described below, thereby evaluating the density or sparsity of the pressure-sensitive adhesive layer.

### <Density Factor>

Each pressure-sensitive adhesive obtained in the examples and comparative example was applied to a release film, and dried at 100° C. for 2 minutes, thereby forming a pressure-sensitive adhesive layer on the release film, and application and drying of the pressure-sensitive adhesive was repeated until the thickness of the pressure-sensitive adhesive layer reached 1.2 mm.

The release film was then removed from the pressure-sensitive adhesive layer, and the rubber-like temperature range, specifically the storage elastic modulus (G′) at 65° C., of the resulting pressure-sensitive adhesive layer was determined using a viscoelasticity tester RDA-III manufactured by TA Instruments, Japan Inc.

The density factor was determined from the storage elastic modulus (G′) based on the formula shown below. Smaller density factors indicate a more dense pressure-sensitive adhesive layer, whereas larger density factors indicate a more sparse pressure-sensitive adhesive layer.

Density factor=3dRT/G′=29.93×(273+65)×10⁶/G′

d: sample thickness, R: gas constant, T: measurement temperature (K), G′: storage elastic modulus (units: Pa)

Each pressure-sensitive adhesive sheet obtained in the examples and comparative examples was also evaluated for heat resistant adhesion, heat and humidity resistant adhesion, the existence of white leakage (heat resistance), removability, and holding force, using the methods described below. The results are shown in Table 2.

### <Heat Resistant Adhesion, Heat and Humidity Resistant Adhesion>

The pressure-sensitive adhesive-treated polarization films obtained in the examples 1 to 6, 8 and 9, and the comparative examples were each cut to a size of 150 mm×80 mm, and were then bonded to both surfaces of a float glass plate of thickness 1.1 mm so that the absorption axes of the polarization films were mutually orthogonal. Subsequently, the glass plate with the polarization films bonded to both surfaces was placed in an autoclave at 50° C. and 5 atmospheres for 20 minutes, thus bonding the polarization films firmly to the glass plate.

The laminated structure comprising the polarization films bonded to both surfaces of the glass plate was then tested for (1) heat resistant adhesion: standing at 100° C. for 1,500 hours, and (2) heat and humidity resistant adhesion: standing at 80° C. and a relative humidity of 90% for 1,000 hours, and was subsequently inspected visually for lifting or peeling of the polarization films, and evaluated using a four level range. The meanings of the symbols used are shown below.

AA: absolutely no lifting or peeling

A: slight lifting or peeling, but not problematic for practical application

B: lifting and peeling noticeable, at a level problematic for practical application

C: lifting and peeling across entire surface, unusable for practical application

In the case of the example 7, the release film was removed from the pressure-sensitive adhesive sheet (release film/pressure-sensitive adhesive layer/polyurethane foam), the polyurethane foam was bonded to a stainless steel plate via the pressure-sensitive adhesive layer, and the laminated structure was inspected visually for lifting or peeling, either after standing at 65° C. for 100 hours (heat resistant adhesion), or after standing at 40° C. and a relative humidity of 90% for 100 hours (heat and humidity resistant adhesion), and evaluated using the three level range shown below.

A: absolutely no lifting or peeling

B: slight lifting or peeling, at a level problematic for practical application

C: lifting and peeling across entire surface, unusable for practical application

### <White Leakage>

For each of the pressure-sensitive adhesive-treated polarization films obtained in the examples 1 to 6, 8 and 9, and the comparative examples, a laminated structure prepared in the same manner as the heat resistant adhesion test, comprising the polarization films bonded to both surfaces of a glass plate, was left to stand at 100° C. for 1,500 hours, and the structure was then inspected visually for the presence of white leakage, and evaluated using the four level range shown below.

AA: absolutely no white leakage

A: slight white leakage, but not problematic for practical application

B: white leakage noticeable, at a level problematic for practical application

C: a marked level of white leakage, unusable for practical application

### <Removability (Reworkability)>

The pressure-sensitive adhesive-treated polarization films obtained in the examples 1 to 6, 8 and 9, and the comparative examples were each cut to a size of 25 mm×150 mm, and the polarization film was then bonded to one surface of a float glass plate of thickness 1.1 mm. Subsequently, the glass plate with the polarization film bonded thereto was placed in an autoclave at 50° C. and 5 atmospheres for 20 minutes, thus bonding the polarization film firmly to the glass plate.

This test piece was then left to stand at 23° C. and a relative humidity of 50% for one hour, a 180° peel test was conducted by peeling the polarization film at an angle of 180° and a speed of 300 mm/minute, and the cloudiness of the glass surface following completion of the peeling was evaluated visually using the three level range shown below.

A: absolutely no problems for practical application

B: slight cloudiness, at a level problematic for practical application

C: adhesive residue across entire surface, unusable for practical application

In the case of the example 7, the release film was removed from the pressure-sensitive adhesive sheet (release film/pressure-sensitive adhesive layer/polyurethane foam), the polyurethane foam was bonded to a stainless steel plate via the pressure-sensitive adhesive layer, and the cloudiness of the surface of the stainless steel plate was then evaluated visually in the same manner as that described above.

### <Holding Force>

Test samples with a width of 2.5 cm were cut from each of the pressure-sensitive adhesive sheets obtained in the examples and the comparative examples, these test samples were bonded to a stainless steel plate so that the bonded area was 2.5 cm×2.5 cm, the bonded samples were left to stand for 20 minutes in an atmosphere at 65° C., a 1 kg weight was suspended from each sample under the same atmosphere, and the time taken for the weight to fall was measured and then evaluated using the three level range shown below.

A: at least 110 hours, absolutely no problems for practical application

B: from 50 to 110 hours, a level problematic for practical application

C: less than 50 hours, unusable for practical application

TABLE 2

| | | | | | Tricyclic diterpene | | | (A) and (B) |
|---|---|---|---|---|---|---|---|---|
| | Copolymer (A) | | | | carboxylic acid (B) etc | | | combined acid |
| | Synthesis | Tg | | Acid value | | Acid value | Density | value |
| | example | (° C.) | Mw | (mgKOH/g) | | (mgKOH/g) | factor | (mgKOH/g) |
| Example 1 | 1 | −44 | 650,000 | 25.8 | D-125 | 13 | 15.5 × 10⁴ | 23.2 |
| Example 2 | 2 | −44 | 680,000 | 25.8 | AZ | 43 | 16.2 × 10⁴ | 29.2 |
| Example 3 | 2 | −44 | 680,000 | 25.8 | D-125 | 13 | 16.0 × 10⁴ | 23.2 |
| Example 4 | 6 | −44 | 800,000 | 25.8 | D-125 | 13 | 14.9 × 10⁴ | 23.2 |
| Example 5 | 7 | −44 | 550,000 | 25.8 | D-125 | 13 | 17.0 × 10⁴ | 23.2 |
| Example 6 | 1 | −44 | 650,000 | 25.8 | D-125 | 13 | 15.2 × 10⁴ | 23.2 |
| Example 7 | 1 | −44 | 650,000 | 25.7 | D-125 | 13 | 15.5 × 10⁴ | 23.2 |
| Example 8 | 2 | −44 | 680,000 | 25.8 | D-125 | 13 | 18.0 × 10⁴ | 23.2 |
| Example 9 | 2 | −44 | 680,000 | 25.8 | D-125 | 13 | 14.0 × 10⁴ | 23.2 |
| Comparative | 8 | −54 | 630,000 | 0.0 | D-125 | 13 | 25.4 × 10⁴ | 2.6 |
| example 1 | | | | | | | | |
| Comparative | 9 | −23 | 720,000 | 85.9 | D-125 | 13 | 12.0 × 10⁴ | 71.3 |
| example 2 | | | | | | | | |
| Comparative | 4 | −44 | 400,000 | 25.7 | D-125 | 13 | 20.2 × 10⁴ | 23.2 |
| example 3 | | | | | | | | |
| Comparative | 5 | −44 | 1,800,000 | 25.8 | D-125 | 13 | 11.5 × 10⁴ | 23.2 |
| example 4 | | | | | | | | |
| Comparative | 10 | −44 | 450,000 | 25.7 | D-125 | 13 | 19.5 × 10⁴ | 23.2 |
| example 5 | | | | | | | | |
| Comparative | 1 | −44 | 650,000 | 25.8 | D-125 | 13 | 28.2 × 10⁴ | 23.2 |
| example 6 | | | | | | | | |
| Comparative | 2 | −44 | 680,000 | 25.8 | none | | 12.0 × 10⁴ | 20.6 |
| example 7 | | | | | | | | |
| Comparative | 3 | 15 | 550,000 | 24.1 | D-125 | 13 | 10.2 × 10⁴ | 21.9 |
| example 8 | | | | | | | | |
| Comparative | 1 | −44 | 650,000 | 25.8 | KR-1840 | 0 | 13.0 × 10⁴ | 20.6 |
| example 9 | | | | | | | | |
| Comparative | 2 | −44 | 680,000 | 25.8 | KR-610 | 170 | 16.0 × 10⁴ | 54.6 |
| example 10 | | | | | | | | |

| | | | Heat and | | | |
|---|---|---|---|---|---|---|
| | Curing | Heat | humidity | | | |
| | agent | resistant | resistant | White | Removability | Holding |
| | (C) | adhesion | adhesion | leakage | (visual) | force |
| Example 1 | AlC | AA | A | AA | A | A |
| Example 2 | AlC | AA | AA | AA | A | A |
| Example 3 | AlC | AA | AA | AA | A | A |
| Example 4 | AlC | A | A | A | A | A |
| Example 5 | AlC | AA | AA | A | A | A |
| Example 6 | TiC | AA | A | A | A | A |
| Example 7 | AlC | AA | A | | A | A |
| Example 8 | NCO | AA | A | A | B | B |
| Example 9 | AlC | A | A | A | B | B |
| Comparative | AlC | C | C | B | C | C |
| example 1 | | | | | | |
| Comparative | AlC | A | A | B | C | C |
| example 2 | | | | | | |
| Comparative | AlC | B | B | A | B | C |
| example 3 | | | | | | |
| Comparative | AlC | B | A | B | B | C |
| example 4 | | | | | | |
| Comparative | AlC | A | B | A | B | B |
| example 5 | | | | | | |
| Comparative | none | C | C | B | C | C |
| example 6 | | | | | | |
| Comparative | AlC | C | C | C | A | B |
| example 7 | | | | | | |
| Comparative | AlC | C | C | C | A | C |
| example 8 | | | | | | |
| Comparative | AlC | B | C | B | C | B |
| example 9 | | | | | | |
| Comparative | AlC | B | B | B | C | C |
| example 10 | | | | | | |

AlC: aluminum chelate-based curing agent
NCO: isocyanate-based curing agent
TiC: titanium chelate-based curing agent

As shown above, pressure-sensitive adhesive sheets with excellent levels of heat-resistant adhesion, heat and humidity resistant adhesion, removability and holding force were able to be formed from the pressure-sensitive adhesives of the examples. From the above results, it is evident that the density factor for the pressure-sensitive adhesive layer is preferably within a range from 14×10⁴ to 18×10⁴.

In those cases where the density factor for the pressure-sensitive adhesive layer is too large, namely when the pressure-sensitive adhesive layer is overly sparse, the following problems are thought to arise. If the pressure-sensitive adhesive layer is overly sparse, then when the pressure-sensitive adhesive sheet is exposed to high temperatures or exposed to conditions of high temperature and high humidity, the sparse nature of the pressure-sensitive adhesive layer makes it impossible to draw the adherend and the sheet-like substrate adequately together to ensure a secure bond. It is thought that as a result, the pressure-sensitive adhesive sheet is prone to lifting from the adherend or foaming. Lifting and foaming are the same in terms of the fact that a dome-shaped portion of air is generated between the pressure-sensitive adhesive sheet and the adherend. However, foaming refers to the occurrence of comparatively small dot-like dome-shaped air portions, whereas lifting refers to the occurrence of larger dome-shaped air portions. Furthermore, those cases where an inability to conform to deformations in the sheet-like substrate leads to dome-shaped air portions between the pressure-sensitive adhesive sheet and the adherend are generally referred to as “lifting”.

In contrast in those cases where the density factor for the pressure-sensitive adhesive layer is too small, namely when the pressure-sensitive adhesive layer is overly dense, the following problems are thought to arise. If the pressure-sensitive adhesive layer is overly dense, then the internally directed force of the pressure-sensitive adhesive layer (which can also be called the internal cohesive force) becomes excessively large. Accordingly, the external cohesive force (commonly called the adhesive force), namely the form of attraction that acts between the adherend and the sheet-like substrate that function as the external members relative to the pressure-sensitive adhesive layer, becomes relatively weak when compared with the internal cohesive force. As a result, it is thought that interface separation occurs between the pressure-sensitive adhesive layer and the adherend and sheet-like substrate, meaning that in the evaluation tests for the holding force, the pressure-sensitive adhesive sheet was unable to satisfactorily resist the 1 kg weight suspended from the sheet, causing the pressure-sensitive adhesive sheet to slide down the stainless steel plate (this phenomenon is referred to as “slip”).

On the other hand, if the acid value for the combination of the copolymer and the tricyclic diterpene carboxylic acid is too low, then as shown in the comparative example 1, because the number of functional groups capable of reacting with the curing agent (C) is too low, the cohesive force of the pressure-sensitive adhesive layer decreases markedly, meaning a satisfactory holding force is unattainable. Furthermore, because the cohesive force is too small, the heat resistant adhesion and heat and humidity resistant adhesion are poor, and when the pressure-sensitive adhesive sheet is peeled off the adherend, residual pressure-sensitive adhesive layer remains stuck to the adherend, soiling the adherend. Moreover, it is also clear from the fact that the density factor is a large value of approximately 25×10⁴ that the pressure-sensitive adhesive layer of the comparative example 1 is more sparse than the layers of the examples, and will therefore exhibit a smaller cohesive force.

If the acid value for the combination of the copolymer and the tricyclic diterpene carboxylic acid is too large, then as shown in the comparative example 2, because the number of functional groups capable of reacting with the curing agent (C) is too high, the internal cohesive force of the pressure-sensitive adhesive layer becomes too large. The fact that the internal cohesive force of the pressure-sensitive adhesive layer is too large is also supported by the fact that the density factor is smaller than those observed for the examples. Because the pressure-sensitive adhesive layer is very dense and the internal cohesive force is large, as described above, interface separation occurs between the pressure-sensitive adhesive layer and the adherend and sheet-like substrate in the evaluation tests for the holding force, causing the pressure-sensitive adhesive sheet to slip down the stainless steel plate. Furthermore, because the number of functional groups is too large, the affinity with the adherend increases, causing marked soiling of the adherend.

If the Mw of the copolymer is too small, then as shown in the comparative examples 3 and 5, because the formed pressure-sensitive adhesive layer is sparse and the external cohesive force of the layer is small, the adhesion (the heat resistant, and heat and humidity resistant adhesion) is poor, and the pressure-sensitive adhesive sheet tends to lift from the adherend or foam. Moreover, because the internal cohesive force is also too low, in the evaluation tests for the holding force, the pressure-sensitive adhesive layer itself tends to rupture (cohesive failure), meaning a satisfactory holding force is unattainable.

If the Mw of the copolymer is too large, then as shown in the comparative example 4, because the formed pressure-sensitive adhesive layer is dense and the internal cohesive force of the layer is overly large, slipping tends to occur between the pressure-sensitive adhesive layer and the adherend and sheet-like substrate, and a satisfactory holding force is unattainable. Furthermore, because the internal cohesive force of the pressure-sensitive adhesive layer is also too large, the forces that suppress heat deformation or heat and humidity deformation of the sheet-like substrate operate overly powerfully, causing white leakage.

Because the comparative example 7 does not contain the tricyclic diterpene carboxylic acid (B), which acts as foreign matter within the copolymer, the pressure-sensitive adhesive layer that is formed is more dense than the layers of the examples, but because the external cohesive force is too small, the adhesion (the heat resistant, and heat and humidity resistant adhesion) is poor, and the pressure-sensitive adhesive sheet tends to lift from the adherend or foam.

When a petroleum-based resin is included instead of the tricyclic diterpene carboxylic acid (B) (the comparative example 9), it was thought that the pressure-sensitive adhesive layer would be more sparse that that of the comparative example 7, but because the compatibility of the copolymer and the petroleum-based resin is poor, the adhesion (the heat resistant, and heat and humidity resistant adhesion) showed little improvement, and the removability actually deteriorated.

If the tricyclic diterpene carboxylic acid (B) is included, but the acid value of the combination of the copolymer (A) and the tricyclic diterpene carboxylic acid (B) is too large, then as shown in the comparative example 10, even though the density factor for the pressure-sensitive adhesive layer is 16×10⁴, the removability is poor, and the holding force also decreases. The reasons for these observations are thought to reflect the fact that because the acid value of the tricyclic diterpene carboxylic acid (B) is too high, a large proportion of the curing agent (C) is consumed by the tricyclic diterpene carboxylic acid (B), which has a markedly smaller molecular weight than the copolymer (A), meaning almost none of the curing agent (C) is available for the cross-linking reaction of the copolymer (A). In other words, because the cross-linking reaction of the copolymer (A) does not proceed satisfactorily, the internal cohesive force is too small, and in the evaluation tests for the holding force, the pressure-sensitive adhesive layer itself tends to rupture (cohesive failure), meaning a satisfactory holding force is unattainable.

If the curing agent (C) is not included at all, then as shown in the comparative example 6, because the cohesive force is too small, all of the performance values are outside the practical application ranges. Furthermore, if the Tg value for the copolymer is too high, then the required adhesiveness cannot be achieved. Accordingly, as shown in the comparative example 8, the adherend is not even soiled.

The pressure-sensitive adhesive of the present invention exhibits a large holding force, namely a large cohesive force, and can be used favorably in optical fields that require a high level of durability. Furthermore, because it comprises a tricyclic diterpene carboxylic acid such as an abietic acid derivative, the pressure-sensitive adhesive also exhibits favorable adhesion to all manner of adherends. Accordingly, the pressure-sensitive adhesive can also be used favorably in a variety of other fields besides the optical field.

1. A pressure-sensitive adhesive comprising a polymer (A), which is formed by polymerization of a radical polymerizable monomer, comprises carboxyl groups, and has a glass transition temperature within a range from −80 to 0° C. and a weight average molecular weight within a range from 500,000 to 1,500,000, a tricyclic diterpene carboxylic acid (B), and a curing agent (C) capable of reacting with a carboxyl group, wherein a total acid value of a combination of the polymer (A) and the tricyclic diterpene carboxylic acid (B) is within a range from 5 to 50 (mgKOH/g).

2. The pressure-sensitive adhesive according to claim 1, wherein the curing agent (C) is a metal chelate compound.

3. The pressure-sensitive adhesive according to claim 1, wherein within a gel permeation chromatogram for the polymer (A), a proportion of an area represented by components with a molecular weight of 2,000,000 or higher is within a range from 3 to 15%.

4. The pressure-sensitive adhesive according to claim 1, wherein the polymer (A) is obtained by a radical polymerization using a polymerization initiator that is divided into a plurality of portions for use, and a peroxide is used in an initial stage of the polymerization.

5. The pressure-sensitive adhesive according to claim 4, wherein the polymerization initiator used in the initial stage is an aromatic peroxide.

6. The pressure-sensitive adhesive according to claim 1, wherein an acid value of the polymer (A) is within a range from 10 to 50 (mgKOH/g), and an acid value of the tricyclic diterpene carboxylic acid (B) is within a range from 5 to 100 (mgKOH/g).

7. The pressure-sensitive adhesive according to claim 1, which comprises from 0.01 to 10 parts by weight of the curing agent (C) per 100 parts by weight of a combination of the polymer (A) and the tricyclic diterpene carboxylic acid (B).

8. The pressure-sensitive adhesive according to claim 1, which is used for an optical application.

9. A pressure-sensitive adhesive sheet, comprising a sheet-like substrate, and a pressure-sensitive adhesive layer formed from the pressure-sensitive adhesive according to claim 1 laminated to at least one surface of the sheet-like substrate.

10. The pressure-sensitive adhesive sheet according to claim 9, wherein the sheet-like substrate is an optical plastic film.

11. The pressure-sensitive adhesive according to claim 10, wherein the optical plastic film is at least one film selected from the group consisting of polyester films, polycarbonate films, triacetate films, cycloolefin films, polyacrylic films, and composite films that comprise at least one of these films as an essential structural layer.

12. A method for producing a pressure-sensitive adhesive, comprising:
polymerizing a radical polymerizable monomer until a polymerizable ratio of 70 to 90% is reached, using from 0.02 to 0.13 mols of a peroxide as a first polymerization initiator relative to 100 mols of the radical polymerizable monomer;
continuing the polymerization using a second polymerization initiator until a polymerizable ratio of at least 99% is reached, thereby synthesizing a carboxyl group-containing polymer (A) with a glass transition temperature within a range from −80 to 0° C. and a weight average molecular weight within a range from 500,000 to 1,500,000; and
mixing the polymer (A), a sufficient quantity of a tricyclic diterpene carboxylic acid (B) to generate a total acid value for a combination with the polymer (A) that is within a range from 5 to 50 (mgKOH/g), and a curing agent (C) capable of reacting with a carboxyl group.
